(19) United States
(12) Patent Application Publication
(10) Pub. No.: US 2002/0008955 A1
(43) Pub. Date: Jan. 24, 2002

(54) Capacitive energy storage device with specialized dielectric

(76) Inventor: William N. Lawless, Westerville, OH (US)

Correspondence Address: Killworth, Gottman, Hagan & Schaeff, L.L.P., Suite 500, One Dayton Centre, Dayton, OH, 45402-2023, US

(21) Appl. No.: 09/848,719

(22) Filed: May 3, 2001

Related U.S. Application Data
(62) Division of application No. 09/304,696, filed on May 4, 1999.

(51) Int. Cl. H01G 4/06

(52) U.S. Cl. 361/311

(57) ABSTRACT

A capacitive energy storage device is provided including a specialized dielectric material. In accordance with one embodiment of the present invention, a capacitive energy storage device is provided including a first electrode layer, a second electrode layer, and a layer of dielectric material positioned between the first electrode layer and the second electrode layer. The dielectric material comprises a ceramic composition comprising a first component and a second component, wherein the first component comprises Lead Magnesium Niobate, and wherein the second component comprises Strontium Titanate. Preferably, the dielectric material has the formula

χPb(Mg_{0.33}Nb_{0.67})O₃+(1−χ)SrTiO₃

where χ is a mole fraction. The first electrode and the second electrode preferably comprise a superconducting ceramic and may comprise a superconducting ceramic in the YBCO family, the NBCO family, or the BSCCO family. A protective sheet of barium zirconate or strontium zirconate may be positioned at an interface between the dielectric layer and an adjacent electrode layer.

### CROSS-REFERENCES TO RELATED APPLICATION

This application is related to U.S. patent application Ser. No. 09/089,759 for CAPACITIVE ENERGY STORAGE DEVICE AND METHOD OF PRODUCING THE SAME, filed Jun. 3, 1998.

### STATEMENT REGARDING FEDERALLY SPONSORED RESEARCH OR DEVELOPMENT

This invention was made with Government support under Contract No. F33615-98-C-2881 awarded by the U.S. Air Force. The Government has certain rights in the invention.

### BACKGROUND OF THE INVENTION

The present invention relates to capacitive energy storage devices for use at cryogenic temperatures, i.e., at any temperature below room temperature, and in particular to a capacitive energy storage device employing a specialized dielectric material.

The storage of energy in banks of capacitors at room temperature is commonplace, particularly in applications where size or weight of the storage capacitors is not a major concern. However, where the size and weight of the capacitive energy storage devices are of significance and are desired to be minimized, and where rapid discharge is desired, there are potential benefits to be obtained by capacitive energy storage at cryogenic temperatures.

These potential benefits are due to the fact that dielectric breakdown field strengths of dielectric materials used in capacitors are generally much larger at low temperatures than at room temperatures. Also, the dissipation factor for such dielectric materials generally decreases with decreasing temperature so that dielectric heating is reduced in charge-discharge operations. The dissipation factor is a measure of internal power losses due to electronic conduction through the dielectric. This power loss results in the thermal dissipation of electrical energy which is undesirable because it raises the temperature of the device and degrades its efficiency. The resistivity of metals falls rapidly with decreasing temperature so that Joule heating in metal components is reduced during discharge at cryogenic temperatures. Finally, the thermal conductivity of ceramics increases with decreasing temperatures so that heat transfer within components is improved at cryogenic temperatures.

In capacitive energy storage devices, the Helmholtz free energy density of the dielectric is the important quantity. The larger the Helmholtz free energy density of the dielectric, the greater the energy per unit volume which can be stored. The Helmholtz free energy density is defined by the following equation:

$$Δ F = \frac{1}{8 π} {\int }_{0}^{{E}_{c}^{2}} ϵ ⅆ {E}^{2} ( cgs ) , \qquad ( 1 )$$

where ΔF is the Helmholtz free energy density, ε is the dielectric constant of the material, E is the electric field strength, and E_{c} is the upper limit of electric field strength.

Some studies of capacitive energy storage at cryogenic temperatures have been published. One study dealt with the impregnation of dielectric films with liquid nitrogen or polar liquids. K. N. Mathes and S. H. Minnich, “Cryogenic Capacitor Investigation,” Final Report, S-67-1095, May 1965. Three types of materials were investigated at 77 K, and it was concluded that energy densities of approximately 0.6 J/cm³ were possible. Energy density may be defined as the energy per unit volume of a medium.

The use of strontium titanate glass ceramic materials as capacitive energy storage devices at cryogenic temperatures was reported by Lawless, Proc. XIII Int'l. Congress of Refrigeration, Washington, D.C., 1971, Vol. 1, p. 599. Based on measurements of electric field strength and dielectric breakdown at 77 K, it was predicted that energy densities of approximately 5.0 J/cm³ were possible.

However, there is a need in the art for materials which can be used as capacitive energy storage devices and which have even greater energy densities. The size and weight of capacitive energy storage devices could be reduced, providing portability to devices which have been heretofore too large and bulky to be mobile. For example, high powered lasers require massive capacitor banks which are too large and heavy to be moved easily. Capacitive devices having large energy densities could reduce the necessary bulk of the capacitors presently utilized in such applications.

U.S. Pat. No. 4,599,677, CAPACITIVE ENERGY STORAGE DEVICE FOR USE AT CRYOGENIC TEMPERATURES, issued Jul. 8, 1986, the disclosure of which is incorporated herein by reference, teaches a capacitive energy storage device utilizing the following ferroelectric pyrochlore ceramic material as the dielectric:

(Cd₁₋ₓPbₓ)₂(Nb_{1-y}Ta_{y})₂O₇.

Alternatively the following non-pyrochlore dielectric materials were identified:

(Sr₁₋ₐBaₐ)TiO₃ and (Pb_{1-b}Ni_{b})₃MgNb₂O₉.

These ceramic materials were found to possess unusually large dielectric constants at temperatures in the range of about 50K to 90K.

However, even in view of the significant advances introduced by the capacitive energy storage devices described in U.S. Pat. No. 4,599,677, there exists a continuing demand for energy storage devices having improved operating characteristics.

### BRIEF SUMMARY OF THE INVENTION

This demand is met by the present invention wherein a capacitive energy storage device is provided comprising a specialized dielectric material. In accordance with one embodiment of the present invention, a capacitive energy storage device is provided comprising a first electrode layer, a second electrode layer, and a layer of dielectric material positioned between the first electrode layer and the second electrode layer. The dielectric material comprises a ceramic material comprising a first component and a second component, wherein the first component comprises Lead Magnesium Niobate, and wherein the second component comprises Strontium Titanate.

Preferably, the dielectric material has the formula

χPb(Mg_{0.33}Nb_{0.67})O₃+(1−χ)SrTiO₃

where χ is a mole fraction. The mole fraction χ may be between about 0.632 and 0.911. The capacitive energy storage device is preferably arranged such that, over a temperature range from about 77 K to about 240 K and under an electric field across the layer of dielectric material of between about 0 kV/cm and about 40 kV/cm, the layer of dielectric material exhibits a maximum dielectric constant of at least about 1700. Alternatively, the capacitive energy storage device may be arranged such that, at a temperature of between about 77 K and about 240 K and under an electric field across the layer of dielectric material of between about 0 kV/cm and about 40 kV/cm, the layer of dielectric material exhibits a dielectric constant of at least 600.

The first electrode and the second electrode preferably comprise a superconducting ceramic and may comprise a superconducting ceramic in the YBCO family, the NBCO family, or the BSCCO family. A protective sheet of barium zirconate or strontium zirconate may be positioned at an interface between the dielectric layer and an adjacent electrode layer.

In accordance with another embodiment of the present invention, a capacitive energy storage device is provided comprising first and second electrode layers having a layer of dielectric material there between. The electrode layers comprise an electrically conductive material characterized by the following formula:

NBa₂Cu₃Oₓ

where Nd is neodymium, Ba is barium, Cu is copper, and O is oxygen. The value of x may be between about 6.5 and about 7.0.

Accordingly, it is an object of the present invention to provide a capacitive energy storage device for use at cryogenic temperatures having improved operational characteristics through proper selection of materials for forming the dielectric layer of the device. Other objects of the present invention will be apparent in light of the description of the invention embodied herein.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals and in which:

FIGS. 1-6 are graphical representations of the operating characteristics of a capacitive energy storage device according to the present invention; and

FIG. 7 is a schematic diagram of a typical capacitor structure which may be used in the practice of the present invention.

### DETAILED DESCRIPTION OF THE PREFERRED EMBODIMENTS

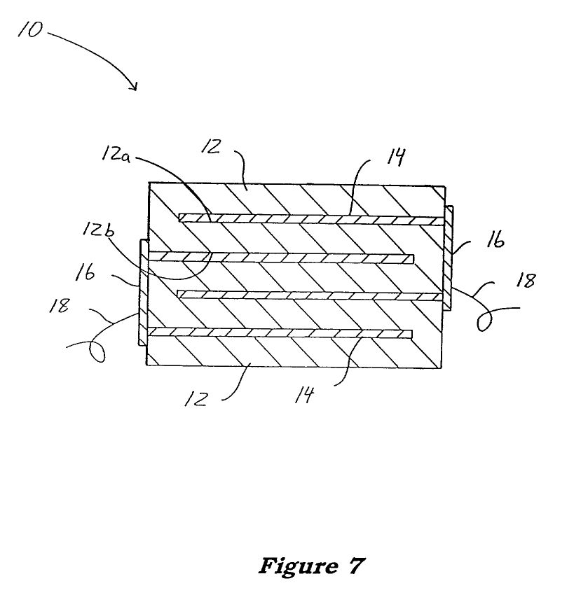

A typical capacitive energy storage device 10 according to the present invention is illustrated in FIG. 7. The storage device 10 incorporates a multilayer structure comprising dielectric layers 12 with interleaved electrode layers 14. Electrically conductive caps 16 make electrical contact to the electrode layers 14 and to power lines 18. Upon electrical discharge, the energy stored in the ceramic layers 1 is released to the power lines 18 via the electrode layers 14 and conductive caps 16 as a large electromagnetic current pulse. While the device illustrated in FIG. 7 is shown with only a few layers for simplicity and ease of understanding, it will be apparent to those skilled in the art that many more layers may be built up in accordance with these teachings to form more complex multilayered capacitive energy storage devices.

The Helmholtz free energy equation, Equation (1) above, indicates that in order to optimize ΔF, the free energy density, both the upper limit of electric field strength, E_{c}, and the dielectric constant of a material ε, should be as large as possible. Lowering the temperature of a dielectric material will permit increases in the upper limit of electric field strength, E_{c}. Thus, operation at cryogenic temperatures in the range of about 50K to about 90K will permit larger E_{c} values. A preferred temperature of operation of the device of the present invention is at or near 77 K, the temperature of liquid nitrogen. Liquid nitrogen is inexpensive, readily available, and has a large specific heat in comparison with liquid helium. Of course, operation at other cryogenic temperatures is possible by utilizing materials such as liquid helium or by utilizing improved cryogenic refrigeration devices. For the purposes of describing and defining the present invention, cryogenic temperatures are utilized herein to refer to any temperature, below room temperature, at which the charge storage device exhibits improved operational characteristics.

The material forming the dielectric layers 12 comprises a ceramic composition in the family defined by the following formula:

χPb(Mg_{0.33}Nb_{0.67})O₃+(1−χ)SrTiO₃

where χ is a mole fraction. In practicing one embodiment of the present invention, ceramic discs were fabricated at high density (i.e., 98 to 99% of the theoretically expected density) at sintering temperatures in the 1100 to 1150 C. temperature range. The mole fractions and designations of the fabricated discs are as follows:

| Designation | mole fraction (x) |
|---|---|
| PMNST-1 | 0.632 |
| PMNST-2 | 0.795 |
| PMNST-3 | 0.911 |

X-ray analyses of these discs showed that they were single-phase, perovskite materials, as desired.

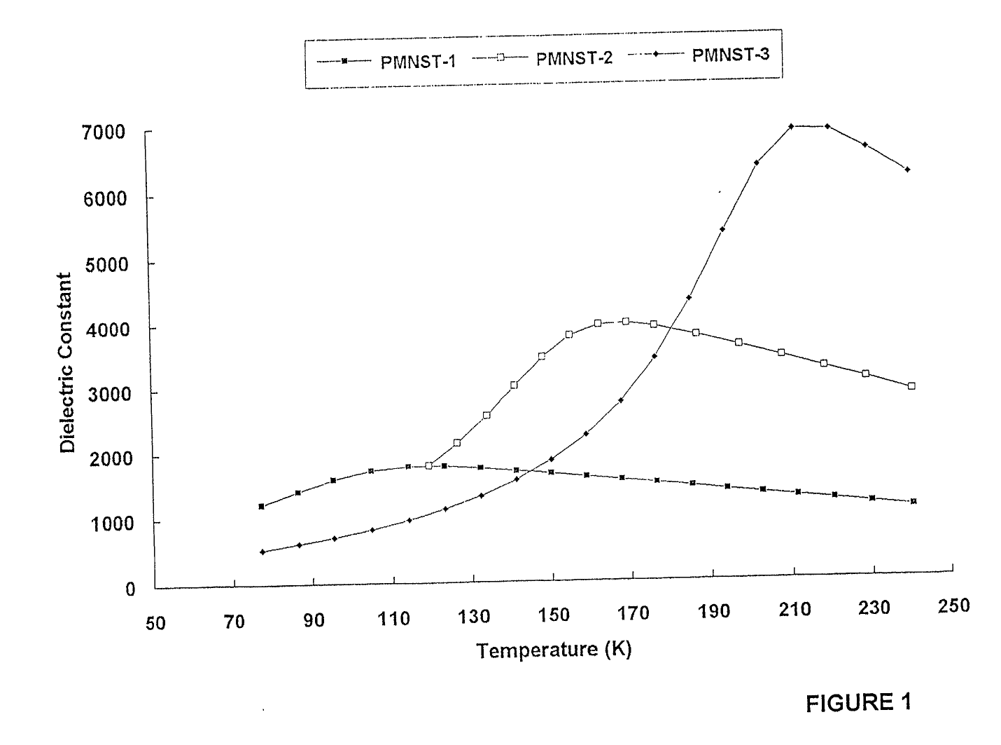

Measurements of the dielectric constants of these three discs as a function of temperature at 1 kHz are shown in FIG. 1 for the cryogenic temperature range of 100 to 250 K. These data reveal two important features. Specifically, the dielectric constants of these discs have very broad maxima in the dielectric constant such that the dielectric constants are only weakly temperature dependent. This is seen most clearly for the PMNST-1 and PMNST-2 discs in FIG. 1. Also, the dielectric constants of the discs are relatively quite large at their maximum values, ranging from about 800 for the PMNST-1 disc to 6000 for the PMNST-3 disc. The temperatures of the dielectric maxima for these three discs are given below together with the values of the maximum dielectric constants.

| | Temp. of Max. | Max Dielectric |
|---|---|---|
| Disc | Dielectric Constant (K) | Constant |
| PMNST-1 | 117 | 1788 |
| PMNST-2 | 166 | 3957 |
| PMNST-3 | 215 | 6211 |

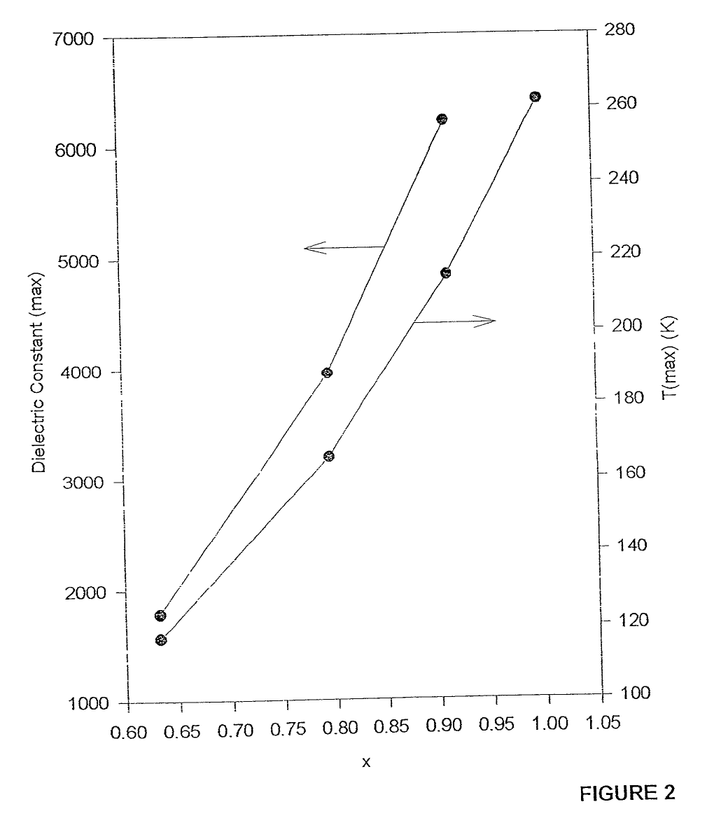

Therefore, the ceramics in this family satisfy two desirable properties; namely, large dielectric constants which are not strongly temperature dependent. The above data are shown plotted in FIG. 2 versus χ, the mole fraction, and these data essentially calibrate the system. Note, however, that a composition with a dielectric-constant maximum at, say, 200 K may have a larger dielectric constant at 180 K than the composition with a dielectric-constant maximum at 180 K. The reason for this is the relatively weak dependence of the dielectric constant on temperature for this family of ceramics.

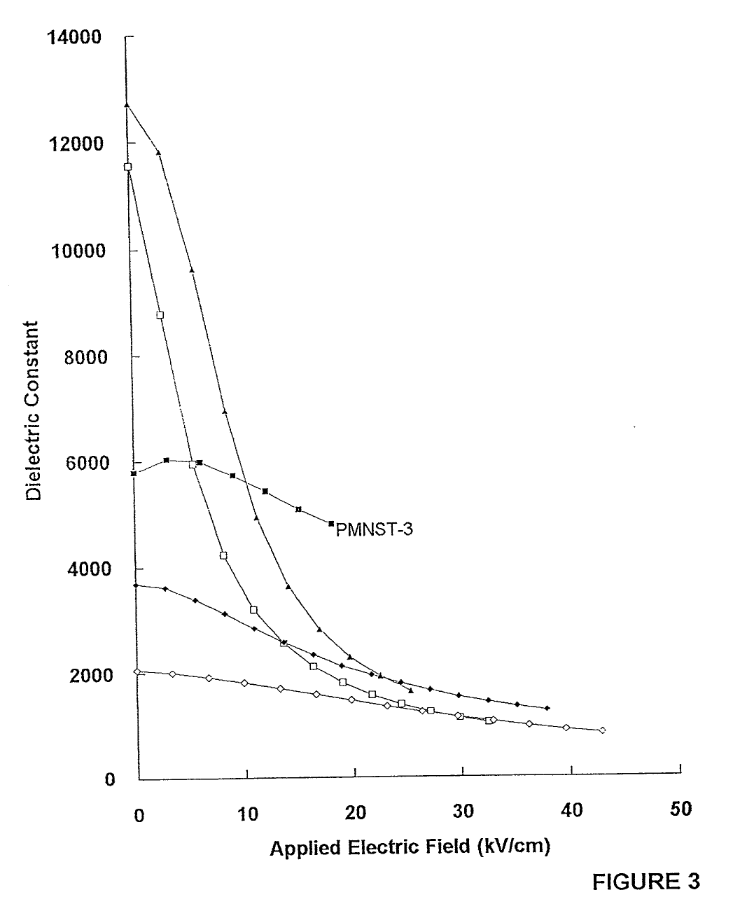

Turning next to the dependence of the dielectric constant on electric field, data measured on the PMNST-3 disc are shown in FIG. 3 in comparison with data measured on other, non-PMNST ceramics. All of these data were measured at about 240 K on samples having dielectric-constant maxima at about 220 K for true comparisons. The non-PMNST samples fall into two categories—those with very large dielectric constants at E=0 (12,000 to 13,000) and those with moderately large dielectric constants at E=0 (2,000 to 4,000). A general trend is clearly evident in FIG. 3. Specifically, for conventional dielectric materials, (i) dielectric materials with large dielectric constants have strong electric field dependancies of the dielectric constant and (ii) dielectric materials with small dielectric constants have weak electric field dependancies of the dielectric constant. The PMNST-3 ceramic occupies a unique position in this hierarchy since it combines a relatively large dielectric constant with a weak electric-field dependence. The PMNST-3 data in FIG. 3 do not extend beyond about 20 kV/cm, but the trend is nonetheless clear.

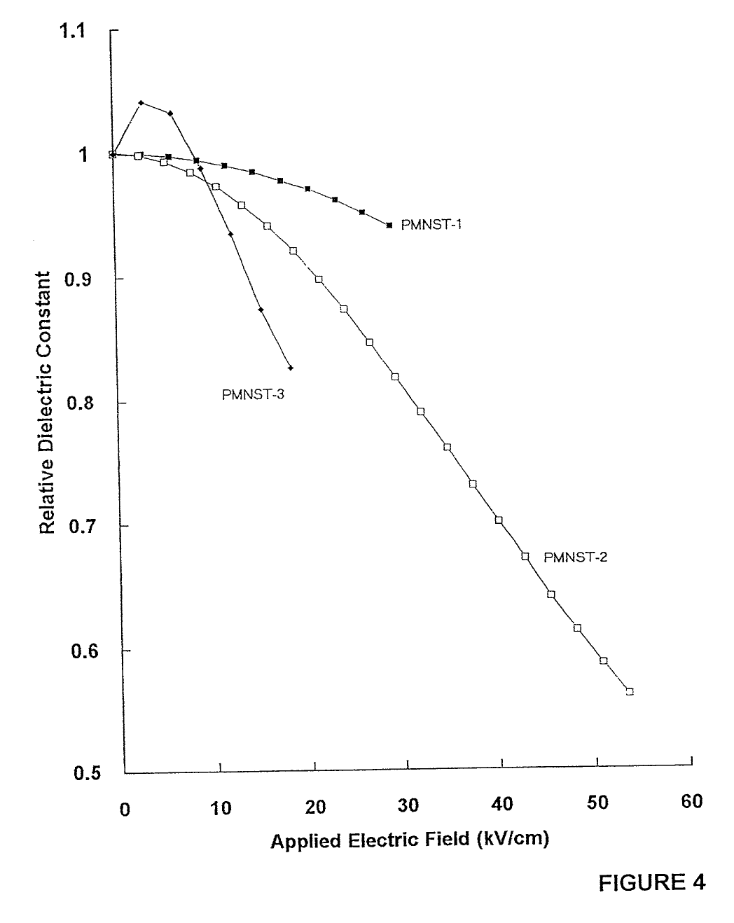

The electric-field dependancies of the dielectric constants measured on the three PMNST discs are plotted in FIG. 4 where all the data have been normalized to the dielectric constant at E=0. The measurements here were done at temperatures in the neighborhood of the maxima in the dielectric constants. These relative data demonstrate that within the PMNST family the general trend mentioned earlier for dielectrics in general also applies here—namely, the larger the dielectric constant, the larger will be the suppression of the relative dielectric constant by an electric field. For example, in FIG. 4 the ordering at, say, 20 kV/cm, is PMNST-1, -2, and -3 in order of increasing field-suppression. However, these field suppressions, while following the general rule, are not as pronounced for the PMNST family of ceramics as for the non-PMNST ceramics.

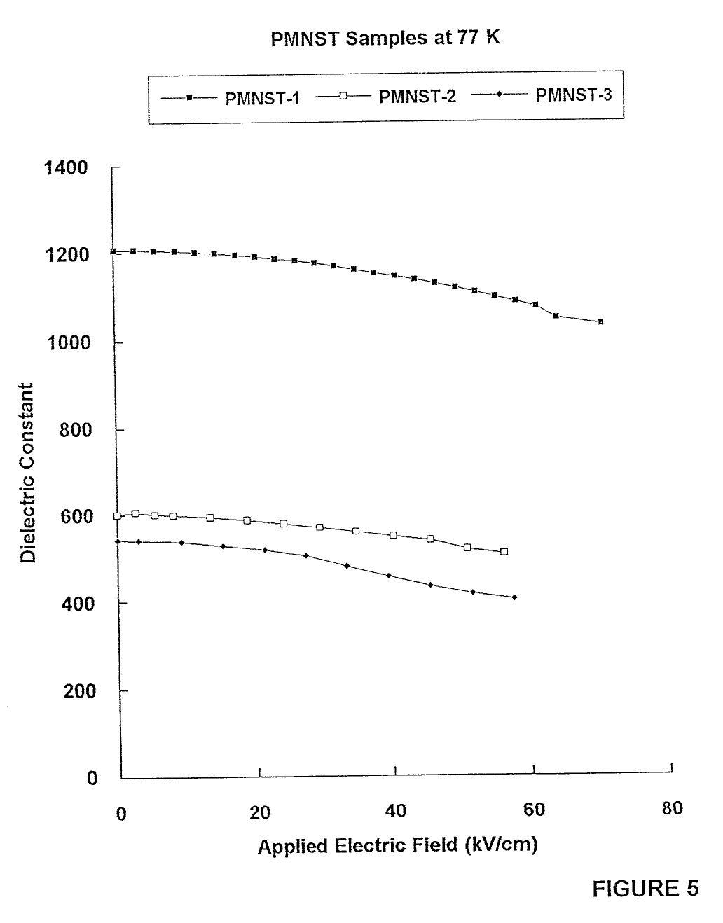

The electric-field dependancies of the dielectric constants of the three PMNST disc samples at 77 K are shown in FIG. 5. Here it is seen that the dielectric constants of all three ceramics have very weak electric-field dependancies at this temperature, and the PMNST-1 has the largest dielectric constant at this temperature as may also be inferred from FIG. 1. The data in FIG. 5 can be numerically integrated to obtain the stored energy density at 77 K according to the relation

$$Δ F = ( 1 / 8 π ) {\int }_{0}^{E} ϵ ⅆ {E}^{2}$$

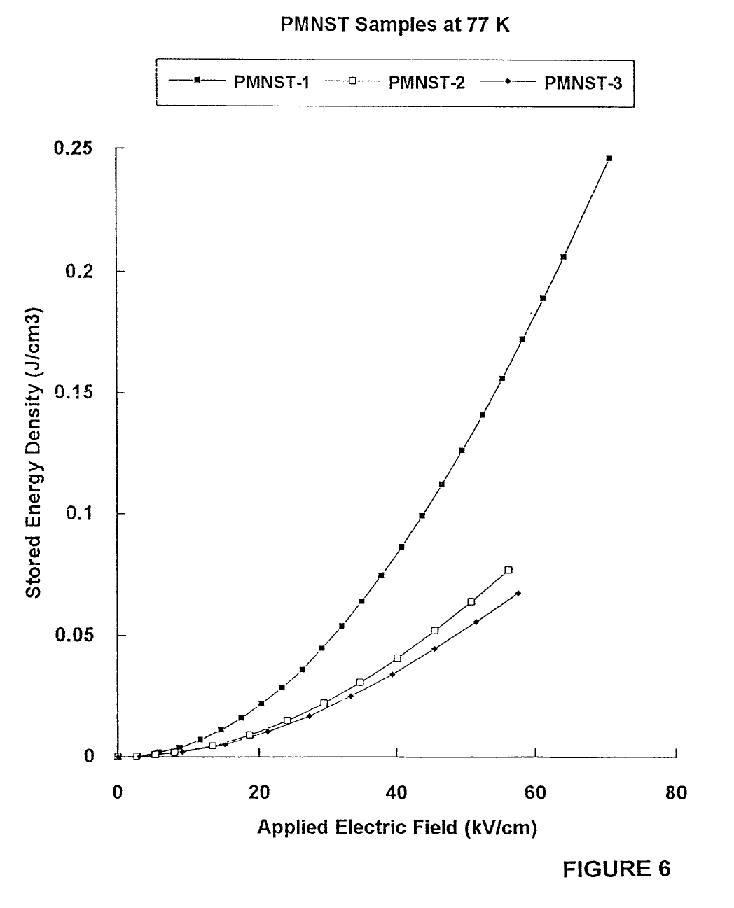

The stored-energy-density data for the three PMNST ceramics are shown in FIG. 6. and it can be seen that the energy density for PMNST -1 increases very rapidly with increasing electric field. There are three reasons for this: First, the dielectric constant is very large; second, the dielectric constant is only weakly field dependent; and third, the stored energy density increases as E² in Eq. (1).

The data in FIGS. 5 and 6 suggest that the PMNST-1 ceramic is the preferred ceramic for energy storage at 77 K. However, it is interesting to observe from FIGS. 1, 2, and 5 that an as-yet unmeasured ceramic composition will have a dielectric constant at 77 K that is larger than that of PMNST-1 and will, therefore, have a larger stored energy density at 77 K.

Regarding the composition of the electrode layers 14, in a preferred embodiment of the present invention, the first electrode and the second electrode comprise a superconducting ceramic. Specifically, the superconducting ceramic may be selected from a composition in the YBCO family, where Y is yttrium, B is barium, C is copper, and O is oxygen; the NBCO family, where N is neodymium, B is barium, C is copper, and O is oxygen; or the BSCCO family, where B is barium, S is strontium, C is copper, C is calcium, and O is oxygen. In the case of the YBCO ceramic, the composition may comprise YBa₂Cu₃Oₓ, where x is a value between about 6.80 and about 6.98. In the case of the BSCCO ceramic, the composition may comprise Bi₂Ca₂Sr₂Cu₃O_{y}, where y is about 10.0±0.2. Preferably, x is a value of about 6.98. In the case of the NBCO family, the composition may comprise NdBa₂Cu₃Oₓ, where x is a value between about 6.5 and about 7.0.

In a particular embodiment of the present invention, the disc of the PMNST-3 composition was painted with a thick slurry of powders of YBCO in an organic vehicle, and this combination was fired in a furnace at 1100 C. for 30 minutes. Next, the disc was sectioned on a diamond saw and the PMNST/YBCO interface was examined under a microscope. It was found that there was no deleterious interaction between the PMNST and the YBCO, and the interface between the two materials was a clean, sharp boundary. This means that these two ceramic materials can be fired together without interacting with one another, and, therefore, the ceramic superconductor can be used as the electrode material in capacitors made with PMNST.

The YBCO ceramic may be a poor choice under some conditions because it is known to melt at about 1000 C. However, if the yttrium in YBCO is replaced with neodymium (“NBCO”), the melting temperature is raised to 1100 C. without sacrificing the superconducting properties of the material. Therefore, NBCO may be the preferred ceramic to be used for electrodes in the PMNST capacitors.

In the fabrication of these capacitors, “green” (unsintered) sheets of PMNST and NBCO would be laminated in an alternating fashion. Next, these laminates are co-fired to produce sintering of the two ceramic materials. It is possible that this processing may produce a deleterious interaction between the two materials. Should this be the case, a third sheet can be added between the PMNST and NBCO sheets to form a protective barrier. An example of such a material to be used in a protective sheet is barium zirconate or strontium zirconate.

A capacitive energy storage device according to the present invention may also be produced by providing a layer of dielectric material 12 having a pair of opposite substantially parallel major faces 12a, 12b. First and second electrode layers 14 are provided on the major faces, and the structure comprising the dielectric layer 12 and the electrode layers 14 are co-fired for a duration and at a temperature sufficient to sinter the material of the dielectric layer 12. Typically, the temperature is between about 950° C. and 1100° C. and the duration is approximately 30 minutes. However, it is noted that the duration and temperature vary depending upon the size of the discrete particles forming the dielectric layer 12. Preferably, the electrode layers 14 are provided in the form of an electrode layer material slurry.

Having described the invention in detail and by reference to preferred embodiments thereof, it will be apparent that modifications and variations are possible without departing from the scope of the invention defined in the appended claims.

1. A capacitive energy storage device for use at cryogenic temperatures comprising:
a first electrode layer;
a second electrode layer; and
a layer of dielectric material positioned between said first electrode layer and said second electrode layer, wherein said dielectric material comprises a ceramic composition comprising a first component and a second component, wherein said first component comprises Lead Magnesium Niobate, and wherein said second component comprises Strontium Titanate.

2. A capacitive energy storage device as claimed in claim 1 wherein said dielectric material has the formula
χPb(Mg_{0.33}Nb_{0.67})O₃+(1−χ)SrTiO₃
where χ is a mole fraction.

3. A capacitive energy storage device as claimed in claim 2 where χ is a mole fraction between about 0.632 and 0.911.

4. A capacitive energy storage device as claimed in claim 2 where χ is a mole fraction of about 0.632.

5. A capacitive energy storage device as claimed in claim 2 where χ is a mole fraction of about 0.795.

6. A capacitive energy storage device as claimed in claim 2 where χ is a mole fraction of about 0.911.

7. A capacitive energy storage device as claimed in claim 1 wherein said capacitive energy storage device is arranged such that, over a temperature range from about 77 K to about 240 K and under an electric field across said layer of dielectric material of between about 0 kV/cm and about 40 kV/cm, said layer of dielectric material exhibits a maximum dielectric constant of at least about 1700.

8. A capacitive energy storage device as claimed in claim 1 wherein said capacitive energy storage device is arranged such that, at a temperature of between about 77 K and about 240 K and under an electric field across said layer of dielectric material of between about 0 kV/cm and about 40 kV/cm, said layer of dielectric material exhibits a dielectric constant of at least 600.

9. A capacitive energy storage device as claimed in claim 1 wherein said first electrode and said second electrode comprise a superconducting ceramic.

10. A capacitive energy storage device as claimed in claim 1 wherein at least one of said first electrode and said second electrode comprises a superconducting ceramic in the YBCO family, where Y is yttrium, B is barium, C is copper, and O is oxygen.

11. A capacitive energy storage device as claimed in claim 1 wherein at least one of said first electrode and said second electrode comprises a superconducting ceramic in the NBCO family, where N is neodymium, B is barium, C is copper, and O is oxygen.

12. A capacitive energy storage device as claimed in claim 11 wherein said first electrode and said second electrode comprise an electrically conductive material characterized by the following formula:
NdBa₂Cu₃Oₓ
where Nd is neodymium, Ba is barium, Cu is copper, and O is oxygen.

13. A capacitive energy storage device as claimed in claim 12, wherein x is a value between about 6.5 and about 7.0.

14. A capacitive energy storage device as claimed in claim 11 wherein a protective sheet of barium zirconate is positioned at an interface between said dielectric layer and at least one of said first electrode and said second electrode.

15. A capacitive energy storage device as claimed in claim 11 wherein a protective sheet of strontium zirconate is positioned at an interface between said dielectric layer and at least one of said first electrode and said second electrode.

16. A capacitive energy storage device as claimed in claim 1 wherein at least one of said first electrode and said second electrode comprises a superconducting ceramic in the BSCCO family, where B is barium, S is strontium, C is copper, C is calcium, and O is oxygen.

17. A capacitive energy storage device for use at cryogenic temperatures comprising:
a first electrode layer;
a second electrode layer; and
a layer of dielectric material positioned between said first electrode layer and said second electrode layer, wherein said dielectric material has the formula
χPb(Mg_{0.33}Nb_{0.67})O₃+(1−χ)SrTiO₃
where χ is a mole fraction.

18. A capacitive energy storage device as claimed in claim 17 wherein at least one of said first electrode and said second electrode comprises a superconducting ceramic in the NBCO family, where N is neodymium, B is barium, C is copper, and O is oxygen.

19. A capacitive energy storage device as claimed in claim 17 wherein a protective sheet of barium zirconate is positioned at an interface between said dielectric layer and at least one of said first electrode and said second electrode.

20. A capacitive energy storage device as claimed in claim 17 wherein a protective sheet of strontium zirconate is positioned at an interface between said dielectric layer and at least one of said first electrode and said second electrode.

21. A capacitive energy storage device for use at cryogenic temperatures comprising first and second electrode layers having a layer of dielectric material there between, said electrode layers comprising an electrically conductive material characterized by the following formula:
NdBa₂Cu₃Oₓ
where Nd is neodymium, Ba is barium, Cu is copper, and O is oxygen.

22. A capacitive energy storage device as claimed in claim 21, wherein said electrically conductive material comprises NBa₂Cu₃Oₓ and wherein x is a value between about 6.5 and about 7.0.

23. A capacitive energy storage device as claimed in claim 21 wherein a protective sheet of barium zirconate is positioned at an interface between said dielectric layer and at least one of said first electrode and said second electrode.

24. A capacitive energy storage device as claimed in claim 21 wherein a protective sheet of strontium zirconate is positioned at an interface between said dielectric layer and at least one of said first electrode and said second electrode.
